(19) United States
(12) Patent Application Publication
(10) Pub. No.: US 2008/0107883 A1
(43) Pub. Date: May 8, 2008

(54) COATED SEALER AND METHOD OF USE

(75) Inventors: Craig Chmielewski, Shelby Twp, MI (US); Abraham Kassa, Shelby Twp, MI (US); Edward Harrison JR., Sterling Heights, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/935,565

(22) Filed: Nov. 6, 2007

Related U.S. Application Data
(60) Provisional application No. 60/864,828, filed on Nov. 8, 2006.

(51) Int. Cl. B32B 3/26; B32B 37/12

(52) U.S. Cl. 428/219; 156/83

(57) ABSTRACT

A sealer is formed having a core material and an adhesive material at least partially coating the core material.

### CLAIM OF PRIORITY

This application claims the benefit of the filing date of U.S. Provisional Ser. No. 60/864,828 filed Nov. 8, 2006.

### FIELD OF THE INVENTION

The present invention relates to a sealer having a core material and an adhesive material at least partially coating the core material. More particularly, the invention relates to a sealer having a foam core material and a foamable and/or curable adhesive material coated on the foam core material wherein the sealer can be employed as a baffle within a cavity of an article of manufacture such as an automotive vehicle.

### BACKGROUND OF THE INVENTION

Industry, particularly the automotive industry, has been seeking to form improved sealants, particularly baffles for automotive vehicles and other articles of manufacture. Traditionally, automotive baffles have been formed of a carrier that is designed to span a cavity of a structure of an automotive vehicle wherein that carrier would include expandable, (e.g., foamable) material about its periphery. When placed in the cavity, the expandable material could be expanded to seal between the periphery of the carrier and the walls of the structure. Formation of such baffles can be expensive since it often requires the formation of a relatively complex shaped carrier using relatively expensive equipment. Moreover, formation of such baffles can require expensive processing machinery to form and locate the expandable material as desired. As such, it would be desirable to form a seal, particularly a baffle, that is relatively easy to manufacture and is relatively low cost.

### SUMMARY OF THE INVENTION

The present invention provides a sealer and a method of forming and/or using the sealer. According to the method, a core material is provided. Preferably the core material is a foam. An adhesive material is coated upon the core material for forming the sealer. The adhesive material is typically activatable to foam, cure or both at elevated temperatures. The sealer, once formed, is typically located within a structure of an automotive vehicle or other article of manufacture. The adhesive material is then activated to adhere to walls of the structure of the automotive vehicle. The core material can be entirely enclosed within the adhesive material, the core material can be enclosed within the adhesive except at ends of the core material or otherwise. The core material can be formed of an elastomeric material. The core material typically has a relatively low density. The adhesive material can include a polymeric base material that is an elastomer resin or an ethylene-based polymer or otherwise. Upon activation, the adhesive material can expand to a volume that is between 110% and 300% relative to its original volume in an unexpanded state.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of an exemplary shaped sealer being inserted within a structure of an automotive vehicle in accordance with an aspect of the present invention.

### DETAILED DESCRIPTION

The present invention is predicated upon the provision of a sealer having a core material with an adhesive material at least partially coating the core material. The present invention is also predicated upon a method of forming and/or using the sealer.

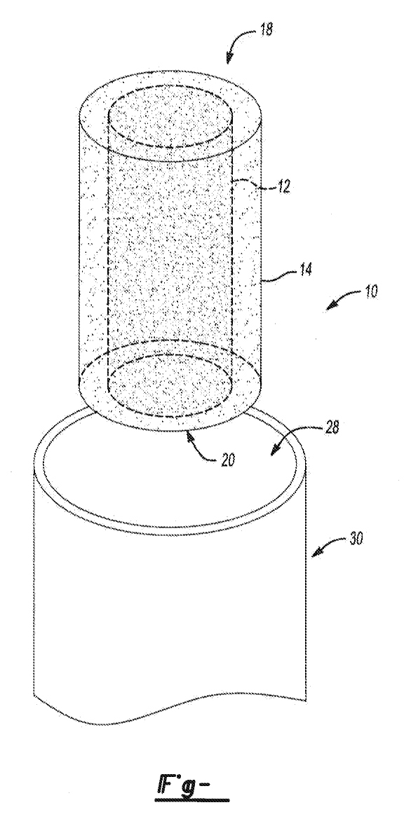

FIG. 1 illustrates an exemplary sealer 10 according to the present invention. The sealer 10 includes a core material 12 and an adhesive material 14, which typically at least partially coats the core material 12. In the particular embodiment shown, the core material 12 is entirely enclosed within or fully coated by the adhesive material 14. However, it is also contemplated that the core material 12 may be only partially or only substantially entirely enclosed within or coated by the adhesive material 14 (e.g., ends 18, 20 of the core material may be exposed).

It is possible that the core material 12 can be formed of a variety of materials such as a solid rubber based material, an elastomeric material or the like. However, in a preferred embodiment, the core material is a foam and preferably an elastomeric foam. Such a foam can be a polyurethane based foam, an elastomeric and/or rubber based foam, a combination thereof or the like. Other materials that are suitable as foams for the core, which may or may not be elastomeric, include, without limitation, EPDM foam, foams of plastic (e.g., thermoplastic), elastomer or both, foams of non-elastomeric polyurethane and foams formed of ethylene copolymer or polyamide.

Typically, the core material will be relatively compressible and/or capable of elongation under relatively low amounts of force or pressure. The core material, particularly when it is a foam but possibly for other materials as well, will typically have a density of less than about 3 g/cm³ although possibly higher, more typically less than about 1.5 g/cm³, even more typically less than about 0.95 g/cm³ and possibly less than about 0.6 g/cm³ or even less than about 0.3 g/cm³. Moreover, the core material, particularly when it is a foam but possibly for other materials as well, will typically have compression deflection values, measured according to ASTM D3574C, of less than about 50 psi although possibly higher, more typically less than about 25 psi, even more typically less than about 15 psi and even possibly less than about 5 psi when measured at 50% compression.

The adhesive material that coats the core material is typically an activatable or foamable adhesive material. In one embodiment, the material may be formed of a heat activated material and may flow, cure (e.g., be thermosettable), foam or a combination thereof upon exposure to heat. The expandable material may be generally dry to the touch and substantially tack free or may be tacky and, in either situation, may be shaped in any form or desired pattern, placement, or thickness, but is preferably of substantially uniform thickness. Exemplary expandable materials are L-4100, L-4200, L-4141, L-7102 and L-7220 foam available through L&L Products, Inc. of Romeo, Mich. Another exemplary expandable material is disclosed in U.S. patent application publication 2004/0266898 titled “Expandable Material”, filed on Jun. 15, 2004 and incorporated herein by reference for all purposes. Yet another adhesive material is sold under the tradename L-2663, which is also commercially available from L&L Products, Inc. Still other possible adhesive materials commercially available from L&L Products, Inc. include, without limitation, L-2700, L-2703, L-2609, and L-2410 or lower expanding versions of these materials.

Though other heat-activated adhesive materials are possible, a preferred heat activated material is an expandable polymer or plastic, and preferably one that is foamable, tacky or both. Particularly preferred materials are elastomer-based, acrylate-based or acetate-based foams, which may be structural but are more typically sealing, sound damping, sound absorbing, sound attenuating or a combination thereof.

A number of sealing, baffling or acoustic activatable adhesive materials may be employed in the present invention. A typical foam includes a polymeric base material, such as an elastomer resin or ethylene-based polymer which, when compounded with appropriate ingredients (typically a blowing and curing agent), expands and cures in a reliable and predictable manner upon the application of heat or the occurrence of a particular ambient condition. From a chemical standpoint, the thermally-activated adhesive material is typically initially processed as a flowable thermoplastic material before curing. It will cross-link upon curing, which typically makes the material incapable of further flow (e.g., thermoset).

One advantage of the preferred adhesive materials over prior art materials is that the preferred materials can be processed in several ways. The preferred materials can be processed by injection molding, extrusion, compression molding or with a mini-applicator. This enables the formation and creation of part designs that exceed the capability of most prior art materials.

While preferred adhesive materials have been disclosed, other materials may be used as well, particularly materials that are heat-activated or otherwise activated by an ambient condition (e.g. moisture, pressure, time, chemical reaction or the like) and cure in a predictable and reliable manner under appropriate conditions for the selected application. Of course, the material may also be formed of non-activatable materials, non-expandable materials or otherwise. Thus, upon activation, the material may soften, cure and expand; soften and cure only; cure only; soften only; or may be non-activatable.

One example of an expandable material is the epoxy based resin disclosed in U.S. Pat. No. 6,131,897, the teachings of which are incorporated herein by reference. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. See also, U.S. Pat. Nos. 5,766,719; 5,755,486; 5,575,526; 6,277,898; 4,898,630; 6,473,611; 6,347,799 and 5,932,680, (incorporated by reference for all purposes). In general, desired characteristics of the material can include adhesion durability properties or the like, although such properties are not necessarily required. Generally, it is desirable that the material does not generally interfere with the materials systems employed by automobile manufacturers or other manufactures.

Other exemplary expandable materials can include combinations of two or more of the following: epoxy resin, polystyrene, styrene butadiene-styrene (SBS) block copolymer, butadiene acrylo-nitrile rubber, amorphous silica, glass microspheres, azodicarbonamide, urea, dicyandiamide. Examples of such materials are sold under the tradename SIKAELASTOMER, SIKAREINFORCER and SIKABAFFLE and are commercially available from the Sika Corporation, Madison Heights, Mich.

In applications where the adhesive material is a heat activated, thermally expanding and/or foaming material, an important consideration involved with the selection and formulation of the material forming the foam is the temperature at which a material reaction or expansion, and possibly curing, will take place. Typically, the material becomes reactive (cures, expands or both) at higher processing temperatures, such as those encountered in an automobile assembly plant, when the material is processed along with the automobile components at elevated temperatures or at higher applied energy levels, e.g., during coating (e.g., e-coat, paint or clearcoat) curing steps. While temperatures encountered in an automobile assembly operation may be in the range of about 148.89° C. to 204.44° C. (about 300° F. to 400° F.) for body shop applications (e.g., e-coat) and, for paint shop applications, are commonly about 93.33° C. (about 200° F.) or slightly higher (e.g., 120° C.-150° C.). If needed, various different blowing agents or blowing agent activators can be incorporated into the composition to cause expansion at different temperatures outside the above ranges. Generally, suitable expandable materials have a volumetric range of expansion ranging from approximately 0 to over 1000 percent. For example a coating mass of expandable adhesive material may expand to form a foam that occupies a volume that is (e.g., is at least partially located within) at least 110%, 150%, 200%, 500%, 1000%, 1500%, 2000% or 3000% of the volume occupied by the original unexpanded mass of expandable material.

The adhesive material or medium may be at least partially coated with an active polymer having damping characteristics or other heat activated polymer, (e.g., a formable hot melt adhesive based polymer or an expandable structural foam, examples of which include olefinic polymers, vinyl polymers, thermoplastic rubber-containing polymers, epoxies, urethanes or the like).

The sealer may be formed using a variety of techniques, but typically such techniques include the formation and/or shaping of the core material and application (e.g., coating) of the adhesive material onto the periphery of the core material. Such formation of the core material and application of the adhesive material make take place simultaneously or the application of the adhesive material to the core material may take place after the formation of the core material.

As one example, the core material can be formed by extrusion to form an extrudate, and more particularly to formed a foam extrudate. The extrudate may then be cut to a desired length, shape or both to form the core material followed by a later application of the adhesive material to the core material to form the sealer. Alternatively, the adhesive material may be co-extruded with the extrudate of core material and then cut to length or shape with the adhesive material already disposed upon the core material for forming the sealer. Such co-extrusion can at least partially form the core material and apply the adhesive material to the core material simultaneously.

The core material may also be molded (e.g., injection molded, compression molded, die molded) to a desired shape, poured to a desired shape or otherwise formed and shaped according to other techniques suitable for forming and or shaping foams or other materials followed by the disposing of the adhesive material on the periphery of the core material. Such adhesive material may be applied to the core material by molding the adhesive material onto the core material, by coating (e.g., brushing, wiping or the like) the adhesive material on the core material, by immersing the core material in the adhesive material as a liquid (e.g., molten liquid), combinations thereof or the like for forming the sealer.

Once formed, the sealer can be applied to a variety of articles of manufacture such as buildings, furniture, vehicles (e.g., automotive or aerospace vehicles) or the like. In or for such articles, the sealer can be used to seal gaps, holes or other openings. The sealer has been found particularly useful as a baffle for automotive vehicle. It is noted that the core material may be a foam material that undergoes further foaming at the same time or a different time that activation of the adhesive material.

With reference to FIG. 1, the sealer 10 is being inserted within a cavity 28 of a structure 30 of an article of manufacture such as a pillar, frame member, body member or the like of an automotive vehicle and the adhesive material 14 adheres the sealer 10 to walls of the structure 30 defining the cavity 28. Generally, it is contemplated that the adhesive material 14 may adhere to the walls of the structure 30 immediately upon insertion within the cavity 28, however, it is generally preferred, that some degree of adhesion occur after insertion into the cavity 28. As an example, for automotive applications, the adhesive material 14 can be configured to activate (e.g., expand, foam, cure, adhere, thermoset or a combination thereof) at temperatures experienced in an e-coat or paint bake oven typical to automotive processing. The initial adhesion upon insertion can be the only adhesion, however, it is generally preferred that the initial adhesion hold the sealer in place until activation.

The core material, the sealer or both are typically shaped to at least partially correspond to the cavity into which the sealer is inserted. The sealer can be held in a desired position within the cavity by virtue of the shape of the sealer forming an interference fit within the cavity, through the used of fasteners, a combination thereof or the like. As an example, a push pin could be extended into the sealer and into an opening of the structure to hold the sealer in place. As another example, the core material could be compressed upon insertion of the sealer in the cavity thereby interference fitting the sealer in the cavity.

Typically upon insertion, the sealer fills a first substantial volume of the cavity and after activation, particularly if the adhesive material is foamable, fills a second substantial volume of the cavity. Upon insertion within the cavity, the sealer typically occupies the first volume and that first volume is at least about 50%, more typically at least about 70%, still more typically at least about 80%, 90% or even 98% of the second volume that the sealer occupies after activation and/or foaming of the adhesive material, although not required unless otherwise stated. It is also typical that the core material represents at least 50% more typically at least 75% and possibly at least 90% by volume of sealer before and/or after activation or adhesion of the adhesive material.

The amount of adhesive material employed can vary for different sealers according to the present invention. For one preferred embodiment, the core material is a large percentage of the sealer by volume such that the adhesive material need not be highly expansive. In such an embodiment, the adhesive material will typically include less than about 3%, more typically less than about 2% and even possibly less than about 1.2% or even 0.8% by weight blowing agent, blowing agent activator or both. Such adhesive material will typically expand to form a foam that occupies a volume that is between about 110% and 300% of the volume occupied by the original unexpanded adhesive material. This can result in significant cost savings.

The sealer, prior to and/or or after activation of the adhesive material, can, if desired, be configured to substantially entirely fill a section of a cavity in which the member has been placed. In such an embodiment, sealer including the core material, the adhesive material or both cooperatively or singly substantially continuously span across a cross-section of the cavity for inhibiting or prohibiting the passage of mass (e.g., dust and debris) and or sound (e.g., noise) through the cavity and/or acting as a baffle. It is generally preferable, although not required, that the core, the adhesive material or both, be substantially self-supporting within a cavity of a structure prior to, during and/or after activation of the adhesive material.

The sealer of the present invention is typically or primarily employed for sound (e.g., noise) reduction within an article of manufacture (e.g., used as a baffle within a cavity of an automotive vehicle). It is contemplated, however, that the sealer may be additionally or alternatively used as a separator, a reinforcement, a hole plug, a blocking member, an opening sealer a combination thereof or the like.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A method of forming and using a sealer, the method comprising:
providing a core material, the core material being a foam;
coating an adhesive material one the core material for forming a sealer, the adhesive material being activatable to foam, cure or both at elevated temperatures; and
locating the sealer within a cavity of a structure of an automotive vehicle;
activating the adhesive material to adhere to walls of the structure of the automotive vehicle.

2. A method as in claim 1 wherein the core material is entirely enclosed within the adhesive material or the core material is enclosed within the adhesive except at ends of the core material.

3. A method as in claim 1 wherein the core material is formed of an elastomeric material.

4. A method as in claim 1 wherein the core material has a density that is less than about 1.5 g/cm³.

5. A method as in claim 1 wherein the core material has a density that is less than about 0.6 g/cm³.

6. A method as in claim 1 wherein the core material has a compression deflection value of less than about 15 psi when measured at 15% compression.

7. A method as in claim 1 wherein the adhesive material includes a polymeric base material that is an elastomer resin or an ethylene-based polymer.

8. A method as in claim 1 wherein the adhesive material, upon activation expands to a volume that is between 110% and 300% relative to its original volume in the unexpanded state.

9. A method as in claim 1 wherein the step of providing the core material includes extruding the core material as the foam.

10. A method as in claim 9 wherein the adhesive material is coated on the core material as a molten liquid.

11. A method as in claim 10 wherein the adhesive material and the core material are cut to form the sealer.

12. A method as in claim 10 wherein the core material is cut and then the adhesive material is disposed thereon for forming the sealer.

13. A method as in claim 1 wherein activation of the adhesive material occurs in an oven for an automotive coating.

14. A method as in claim 1 wherein the sealer is shaped to correspond to the cavity of the structure.

15. A method as in claim 1 wherein the adhesive material include blowing agent, blowing agent accelerator or both, but includes less than about 2% by weight blowing agent and blowing agent accelerator.

16. A method of forming and using a sealer, the method comprising:
providing a core material, the core material being a foam;
coating an adhesive material one the core material for forming a sealer, the adhesive material being activatable to foam, cure or both at elevated temperatures, wherein:
i. the core material is entirely enclosed within the adhesive material or the core material is enclosed within the adhesive except at ends of the core material;
ii. the core material is formed of an elastomeric material;
iii. the core material has a density that is less than about 0.6 g/cm³;
iv. the core material has a compression deflection value of less than about 15 psi when measured at 15% compression;
v. the adhesive material includes a polymeric base material that is an elastomer resin or an ethylene-based polymer; and
vi. the adhesive material is coated on the core material as a molten liquid
locating the sealer within a cavity of a structure of an automotive vehicle wherein the sealer is shaped to correspond to the cavity of the structure; and
activating the adhesive material to adhere to walls of the structure of the automotive vehicle, wherein:
i. the adhesive material, upon activation expands to a volume that is between 110% and 300% relative to its original volume in the unexpanded state;
ii. activation of the adhesive material occurs in an oven for drying an automotive coating.

17. A method as in claim 15 wherein the step of providing the core material includes extruding the core material as the foam.

18. A method as in claim 16 wherein the adhesive material and the core material are cut to form the sealer.

19. A method as in claim 16 wherein the core material is cut and then the adhesive material is disposed thereon for forming the sealer.

20. A sealer, the sealer comprising:
a core material, the core material being a foam;
an adhesive material coated over the core material, the adhesive material being activatable to foam, cure or both at elevated temperatures, wherein:
i. the core material is entirely enclosed within the adhesive material or the core material is enclosed within the adhesive except at ends of the core material;
ii. the core material is formed of an elastomeric material;
iii. the core material has a density that is less than about 0.6 g/cm³;
iv. the core material has a compression deflection value of less than about 15 psi when measured at 15% compression; and
v. the adhesive material includes a polymeric base material that is an elastomer resin or an ethylene-based polymer;
vi. the adhesive material, upon activation expands to a volume that is between 110% and 300% relative to its original volume in the unexpanded state;
vii. activation of the adhesive material occurs in an oven for drying an automotive coating.
